(19) United States
(12) Patent Application Publication
(10) Pub. No.: US 2003/0033124 A1
(43) Pub. Date: Feb. 13, 2003

(54) Apparatus and method for the calculation of dose deposition and shielding

(76) Inventor: Paul Kehler, Grafton, MA (US)

Correspondence Address: PAUL KEHLER, 109 KEITH HILL RD., GRAFTON, MA, 01519, US

(21) Appl. No.: 10/216,020

(22) Filed: Aug. 9, 2002

Related U.S. Application Data
(60) Provisional application No. 60/311,298, filed on Aug. 10, 2001.

(51) Int. Cl. G06F 17/10

(52) U.S. Cl. 703/2

(57) ABSTRACT

This invention deals with two novel photon interaction coefficients, the dose deposition coefficient and the shielding coefficient, which are function of not only the photon energy and the Z-number of the shielding material, but also of the thickness of the shielding material. These coefficients consider the energy degradation of photons as they pass through matter, and allow for calculations of the dose deposited in internal organs and in shielded objects, as well as for accurate shielding calculations without use of the common dose buildup factor.

### BACKGROUND OF THE INVENTION

Photons (gamma rays and X-rays) are everywhere. They have natural origins (cosmic radiation or radiation emitted by naturally occuring minerals), are undesired byproducts of nuclear technologies (nuclear reactors), or are intentionally generated for beneficial medical and industrial applications. The effects of radiation are detrimental to human health when certain radiation levels are exceeded. In industrial and medical applications, radiation must be applied at predetermined levels. It is important, therefore, to be able to compute the dose levels to which humans and materials are exposed in certain environments, as well as to calculate the shielding necessary to protect humans and materials from excessive radiation levels.

Accurate dose deposition and shielding calculations are not easy, because of the large number of interactions possible between photons and matter. The most important interactions are coherent scattering, photoelectric absorption, Compton scattering, and pair production. The probability for any of these interactions to take place varies with the atomic number Z of the exposed elements and the energy of the incident photons, and can be calculated by use of well known partial photon interaction coefficients which can be found in many publication, such as in Cit. 1 in the Information Disclosure Form attached to this specification. FIG. 1, for example, shows partial photon interaction coefficients of lead. These “partial coefficients” express the probability of a single type of interaction of a photon with matter, and are used in so-called “Monte-Carlo” programs, run on large mainframe computers, to simulate accurately the transport of photons through matter and the dose deposited by photons in matter. Unfortunately, use of Monte-Carlo techniques requires large investments of time and money. The calculation of dose deposited in even the simplest multilayered substances may require many hours of CPU-time of large mainframe computers. Therefore, they are useful only for fundamental studies or in situations where extreme accuracy of the calculated data is required.

Two “total coefficients” were introduced for practical use in computational industrial and medical nuclear physics. They are the “attenuation coefficient” and the “energy absorption coefficient”, and are based on the partial coefficients discussed above. The attenuation coefficient is the sum of all partial coefficients and is shown in FIG. 1 for lead. The attenuation coefficient is larger than the energy absorption coefficient, because the energy absorption coefficient does not include the scattered photon components of the elastic scattering and the inelastic scattering (Compton effect) interactions.

When the attenuation coefficient is used in calculations of photon interactions with matter and when all photons that interact with the matter are excluded from further consideration, then the attenuation of a beam of incident photons can be calculated by the well-known exponential-decay relation of Equation 1:

I=I₀e^{82 d}, (Eq.1)

where

I=Intensity of the transmitted beam,

I₀=Intensity of the incident beam,

μ=attenuation coefficient of the shield, and

d=thickness of the shield.

Equation 1 computes correctly the attenuation of the original beam as far as the number of photons per unit area is concerned. It applies to “narrow beam” or “good geometry” situations. For example, when a window is to be designed for a detector that measures radiation of only the original energy, then only the number of photons with original energy is of importance, and Equation 1 applies.

In many technical and medical applications, however, it is not the reduction of the number of original photons that is of primary interest, but the reduction of energy fluence and the deposition of dose. Commonly, energy absorption coefficients are being used for the calculation of dose deposition in matter. For lack of anything better, energy absorption coefficients were and still are also being used for many shielding calculations. ASTM Standard E666-91 (Cit. 2), for example, specifies that an Eq. 2 be used for calculations of reduction of energy fluence, which is similar to Eq. 1 except that energy absorption coefficients be used in these shielding calculations instead of the attenuation coefficients of Eq. 1. Dose-sensitive shielding problems requiring the use of energy absorption coefficients are sometimes referred to as “broad beam” or “bad geometry” situations and are calculated as

I=I₀e^{μd}, (Eq. 2)

where

I=Intensity of the transmitted beam,

I₀=Intensity of the incident beam,

μ=energy absorption coefficient of the shield, and

d=thickness of the shield.

Energy absorption coefficients are smaller than attenuation coefficients because they do not include the scattering components of the attenuation coefficients. Both these coefficients are readily available from many sources. Unfortunately, neither of these coefficients yields accurate results in dose shielding calculations. This is demonstrated in FIG. 2 (from Cit. 3), which compares calculations performed with attenuation coefficients (μ₀) and energy absorption coefficients (attenuation coefficient minus scattering components, μ₀−σ_{S}).

FIG. 3 shows that neither the use of attenuation coefficients nor the use of energy absorption coefficients results in accurate calculations of transmission of energy fluence. Following traditional lines of thinking, the solution to this problem was attempted by introduction of a build-up factor B (shown in FIG. 2) which, after being applied to transmission calculations performed with attenuation coefficients, was supposed to yield a beter measure for the transmission of fluence than Eq. 2. The corrected Eq. 1 reads, then

I=BI₀e^{μd}, (Eq.3)

where μ is the total attenuation coefficient,

and the buildup factor B=B(d,E,G, R) is a function of the thickness d of the shield, the energy E of the original radiation, the geometries G of the detector and the materials surrounding the detector and of R, the response of the dose detector.

Basically, B is defined as

B=(observed dose rate)/ (p dose rate), or

B=1+(dose rate due to scattered radiation)/(primary dose rate)

Because of the dependence of B on so many parameters, its accurate measurement or calculation is more art than science. In some situations, the dose is measured or calculated for infinite media, i.e., the backscatter component is included in the buildup factor. In other cases, the buildup of dose behind slabs of shielding materials is of interest, without significant backscattering from surrounding materials. The response of the dose-detector is very rarely mentioned in any of the publications of measured buildup factors. Clearly, standards in this area are still to be defined. Until such time when standardization of these terms is generally agreed upon, we will assume that the commonly used term “Dose Buildup Factor” is a measure for the buildup of energy fluence in an infinite medium due to scattered and secondary photons, and that the term “dose” itself stands for the “deep dose” as specified in 10 CFR PART 20. A rough rule of thumb is that B for thick slab absorbers tends to be equal to the thickness of the absorber, when measured in units of mean free paths of the incident gamma radiation (Cit. 4). However, the linear increase of B with absorber thickness levels off at about five mean free paths (Cit. 3), as can be seen in FIG. 2.

Gamma Ray Attenuation Coefficients and Buildup Factors for Engineering Materials can be found in ANS Standard ANS-6.3.4-1991. A more recent investigation of the buildup of energy fluence (dose) in absorbers is presented in Cit. 5. In this publication, CEPXS/ONELD results of dose deposition calculations are presented for for Co⁶⁰ gamma rays (1.25 MeV) in aluminum, silver and lead. The calculated results were fitted by a function containing the total attenuation coefficient, the energy absorption coefficient and two constants, f and B. The “physically based” fitting function was found to be

I=I₀exp(μₐd)exp(ln(B)(1−exp(−(μₐ−fμₑ)/ln(B)))) (Eq. 4)

where

f and B are two constants,

μₐ is the attenuation coefficient, and

μₑ is the energy absorption coefficient.

This equation for the calculation of transmitted energy fluence can be simplified to

I=I₀exp(−fμₑd) (Eq. 5)

for small d, and to

I=BI₀exp(−μₐd) (Eq. 6)

for large d.

Compare the Equations 5 and 6 to the Equations 2 and 3.

The constant f was found to be (in Cit. 5)1.205 for Al, 1.302 for Ag, and 1.372 for Pb. The constant B was found to be 6.479 for Al, 5.044 for Ag, and 3.179 for Pb.

The current state of the art is, then, that two different coefficients, the attenuation coefficient and the energy absorption coefficient, are used for the calculation of shielding and dose deposition, respectively. Neither calculation is accurate, and the concept of a build-up factor was introduced to increase the accuracy of shielding calculation. Because of the complexity of the problem, no correction factors (similar to the dose buildup factor B) were derived for the improvement of the accuracy of dose deposition calculations. The good old energy absorption coefficient μₑ is still being used for this purpose. Unfortunately, the equtions using this coefficient (Eq. 2 and Eq. 5) are accurate only for he surface layers of unshielded objects. The dose deposited in shielded objects (such as internal human organs) is not calculated accurately by use of these energy absorption coefficients and simple engineering equations. The current state of the art requires that the above mentioned cumbersome and expensive Monte-Carlo techniques be used for reasonably accurate calculations of dose deposition in shielded objects.

In the real world, dose deposition and shielding are related to one another. Shielding is the integral of all the dose deposited in the traversed matter. Deposited dose is the differential of dose shielding functions: the dose deposited in a layer of thickness δ at a depth d in an absorber is equal to the difference of the transmitted (shielded) energy fluences at the depths d and d+δ. It would be consistent with physics processes and the modeling and calculating of dose deposition and shielding would be easier if both the dose deposition process and the shielding process were described by only one coefficient and if there were no need for correction factors. In the present state of the art, one type of coefficients (energy absorption coefficients) is used for dose deposition calculations, a second type of coefficients (attenuation coefficients ) and a correction factor B is used for the calculation of shielding, and no correction factors were developed for the calculation of dose deposition in shielded objects. In the present invention, the coefficients used for the calculation of dose deposition and for the calculation of shielding are related to one another as they should be.

### BRIEF SUMMARY OF THE INVENTION

The present invention deals with a novel method for the calculation of dose deposition in matter by photons (X-rays and gamma rays), and for the calculation of shielding of photon radiation. The significant feature of the new method is the use of two new types of photon interaction coefficients with matter. Photons can interact in a number of different reactions with the nuclei of atoms, and probabilities of these interactions (i.e., photon interaction coefficients), have been calculated and published for all common interactions, for all elements, and for all photon energies of interest to people working in the fields of nuclear science and engineering, nuclear medicine, and health physics. All these coefficients are a function of the photon energy and the Z-number of the elements with which they interact. This is all that is needed for the statistical simulation (by Monte-Carlo techniques) of the transport of photons through matter and for the calculation of the resulting energy deposition in this matter as well as the attenuation (shielding) of the originally incident photon intensity. It is true that many photons change their energy during their passage through the matter, but the Monte-Carlo methods account for this change by simply using interactions coefficients which are correct for the new energies.

Back-of-the-envelope type of engineering calculations are being performed with two types of coefficients (the total attenuation coefficient and the energy absorption coefficient) which are sums of some of the known individual interaction coefficients. These sums of coefficients are functions of only the energy of the incident photons and the effective Z-number of the matter, just as their summands. It is not surprising, therefore, that the results of dose deposition and shielding calculations performed with these coefficients are not too accurate, since the energy of some photons change as they pass through finite thickness of the absorber.

The significant feature of the novel method claimed in this invention is the introduction of two new types of coefficients: one for the calculation of the dose deposition in shielded objects, and the other one for the calculation of the reduction of photon fluence (shielding of dose). These two new photon interaction coefficients are not only functions of the energy of the incident beam of photons and the effective Z-number of the exposed object, but also of the thickness of the shield (in the case of shielding calculations) or the distance of the volume increment of interest from the exposed surface of the irradiated object (in case of dose deposition calculations). Making these two new coefficients dependent on the length of the photon path though exposed objects, allows for consideration of the effects of the change of the average energy of the photons as they pass through the exposed object.

There are many ways to define the two new coefficients. They are of semi-empirical nature and calculated results can be verified by tests. Depending on the complexity of the problem and the desired accuracy, the methods to calculate these coefficients can be very simple or more involved. Only the very simplest cases and models can be conveniently handled by hand-held calculators. In most cases, microprocessors with sufficiently fast processors will be needed for practical use in scientific, industrial and medical applications.

It is expected that the introduction of this method will increase the speed and accuracy of calculations in many fields. It will become possible to calculate (with engineering-type semi-empirical methods) the dose deposited in internal objects. This can not be done today. It will no longer be necessary to bother with Buildup Factors when performing shielding calculations. Density and thickness gauges in industrial applications will perform with greater accuracy over a wider range of test conditions. In the medical field, nuclear diagnostic techniques (CAT-scans) will become more accurate.

### BRIEF DESCRIPTION OF THE DRAWINGS

FIG. 1 shows the common Photon Interaction Coefficients of Lead. Shown are the fundamental coefficients of Photoelectric Absorption, Compton Scattering, Coherent Scattering and Pair Production. These coefficients, defining the probability of photons of given energies to interact with lead in a particular manner, can be calculated theoretically. The “Total Attenuation” coefficient of lead, which is the sum of all fundamental coefficients, is also shown in this Figure.

FIG. 2 shown the dose buildup in lead by 1.2 MeV photons (from Co⁶⁰). Derived from Cit. 3.

FIG. 3 shows (diamonds) the dose deposition coefficients that should be used at various depths of lead shields to come up with the measured dose transmission curve of FIG. 2. It also shows (thin line) the dose deposition coefficients calculated by the preferred embodiment of the invention. The lower horizontal (heaviest) line is the energy absorption coefficient for 1.2 MeV photons in lead, and the upper horizontal line is the attenuation coefficient.

FIG. 4 shows transmitted dose calculations performed with shielding coefficients that were derived from the dose deposition coefficients of FIG. 3. The calculated values are compared with the experimental data of FIG. 2.

### DETAILED DESCRIPTION OF THE INVENTION

It was discussed in the text above that the current art requires two separate coefficients, the attenuation coeffcient μₐ and the energy absorption coefficient μₑ, for the calculation of dose transmission and dose deposition, respectively. Both μₐ and μₑ are functions of the atomic number Z of the absorber and the energy E of the photon,

μₐ=μₐ(Z,E) and (Eq. 7)

μₑ=μₑ(Z,E).

This is not a very elegant way of doing things, and, what is worse, does not describe properly the processes involved in dose deposition and dose shielding. In the real word, dose deposition and shielding are related to one another, and one can be calculated from the other one by integration or by differentiation. Current experimental techniques allow for measurements of both the transmission and the deposition of dose. Thus, when dose transmission data are known, dose deposition data can be derived by differentiation of the transmission data. On the other hand, when dose deposition data are known, dose transmission data can be calculated by integration of the dose deposition data.

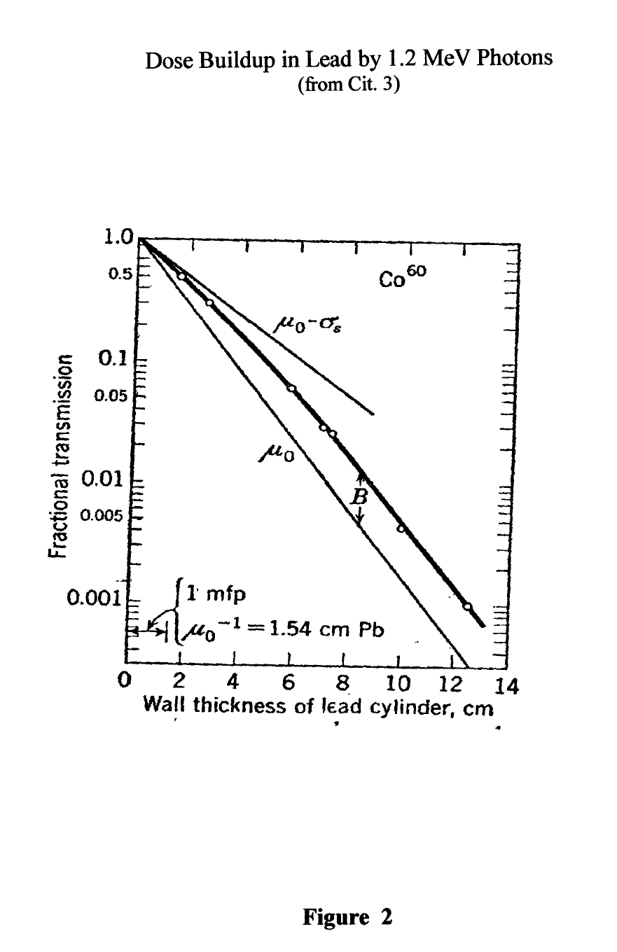

The FIG. 2 shows experimentally determined dose transmission data for 1.2 MeV photons and lead, as well as the “transmissions” calculated by the common attenuation coefficient (lower straight lin) and the energy absorption (upper straight line) coefficients. Dose deposition at any depth d can be determined by differentiation (calculation of the slope) of the dose transmission data of FIG. 2. Examination of the Figure shows that, at thickness of 0 cm of the lead, the slope of the measured dose transmission curve is equal to the slope of the transmission curve calculated by use of the energy absorption coefficient μₑ of lead, and the true dose deposition δD₀ at zero thickness is calculated by

δD₀=I₀μₑδd (Eq. 8)

where

δd is a thickness increment.

On the other hand, the dose deposition at a depth T that is much larger than the mean free path L of the photons, T>>L, the slope of the measured dose transmission curve is equal to the slope of the dose transmission curve calculated by use of the attenuation coefficient μₐ of lead, and the dose deposition δD_{T} at the thickness T is calculated by

δD_{T}=I_{T}μₐδd (Eq. 9)

The Equations 8 and 9 represent well known facts and are understood by interpretation of the definitions of the attenuation coefficient and the energy deposition coefficient.

In the general case, the dose δD_{d} deposited at the depth d is calculated by

δD_{d}=I_{d}μ_{d}δd (Eq. 10)

where

I_{d}=energy fluence at the depth d, and

μ_{d}=dose deposition coefficient at the depth d.

Obviously, dose deposition coefficients are functions of not only the energy E and the atomic number Z (as are the attenuation coefficients and the energy deposition coefficients, see Eq. 7), but also of the depth d in the absorber,

μ_{d}=μ_{d}(Z,E,d) (Eq. 11)

The introduction of dose deposition coefficients μ_{d}, methods to derive such dose deposition coefficients for all energies, substances and depths, and the use of this coefficient for the calculation of dose deposited in shielded matter is the main novel feature of this invention. The introduction of a shielding coefficient μₛ and the use of this coefficient for the calculation of dose shielding is another novel feature of this invention. Both these coefficients are related to one another. The second one can be determined by integration of the first one, and the first one can be determined by differentiation of the second one.

Dose deposition coefficients as well as shielding coefficients have real physical meaning and can be determined independently by tests. An example how dose deposition coefficients can be determined from experimentally measured shielding data is given below.

The novel dose deposition coefficients and shielding coeffcients have numerical values which range between the well known and commonly used attenuation coefficients and energy absorption coefficients, and can be derived by interpolation between attenuation coefficients and energy absorption coefficients. Interpolations can be performed by very simple (linear) or more conplex (higher order, exponential, logarithmic, trigonometric) functions.

Except when used only occasionally and for very simple problems, the invented method is too cumbersome and slow to be used manually with published attenuation and energy absorption coefficients. The ubiquitous personal microcomputers in use toady, as well as dedicated micromputers in scientific, industrial and medical equipments are perfect tools for the implementation of the invented method. Obviously, large mainframes can also be used for shielding and dose deposition calculations using the invented method, but this would be like shooting sparrows with a large gun. There are no special requiremets the computers must meet to implement the invented method, except they must be fast enough for convenience, must be able to store the data needed to compute dose deposition coefficients and shielding coefficients, and must be able to execute computer programs for the calculation of these coefficients.

The data necessary for the computation of the novel coefficients of this invention can be stored in the computer or in the executable computer program in form of a three-dimensional (or two-dimensional) arrays of discrete novel coefficients which were previously derived experimentally or calculated by other computer programs. Dose deposion coefficients and shielding coefficients for other canditions than those presented by the elements of the stored array can be determined by interpolation or extrapolation of the stored discrete coefficients. Mainframe computers and Monte-Carlo techniques can also be used to calculate discrete values for dose deposition and dose shielding, and these calculated values can then be used for the calculation of the dose deposition coefficients or shielding coefficients. Discrete values for dose deposition and dose shielding, to be used for derivation of the novel dose deposition and dose shielding coefficients could, naturally also be computed by other than Monte-Carlo techniques. For example, dose shielding coefficients could be calculated for dose shielding calculations performed by Eq. 4 and published (or calculated) values for f and B.

One embodiment of the invention is, therefore, to store in a three-dimensional array as many experimentally measured dose deposition coefficients as are available, as function of Z, E and d, and calculate other needed dose deposition coefficients by interpolation or extrapolation of the measured data.

It is also possible to reduce the dimension of the array of stored coefficients by lumping together two of the significant parameters of the coefficient, the energy Z and the depth d, into one, i.e, into a calculated mean free path. Another embodiment of the invention is, therefore, the storage of dose deposition coefficients and shielding coefficients in a two-dimensional array that has the mean free path as one of its significant parameters and the energy of incident photons as the other one.

Another simplification of the stored array of dose deposition coefficients and shielding coefficients is possible by not storing the absolute values of the coefficients but, instead, a factor F (between 0 and 1) which is then used to calculate dose deposition coefficients by

μ_{d}=μₑ+F(μₐ−μₑ) (Eq. 12)

The dose deposition coefficient has its minimum value (See Eq. 8) for F=0, and its maximum value (see Eq. 9) for F=1. A similar equation, with a different factor F, can be used for the calculation of shielding coefficients. Another embodiment of the invention is, therefore, the storage in an array not of the absolute value of the novel coefficients but, instead of a factors F which are then used to calculate dose deposition coefficient according to Eq. 12 and shielding coefficients by an equivalent equation.

Preliminary investigations have shown that the interpolation factors F of Eq. 12 are not too different for all known elements. Therefore, instead of storing many experimentally derived novel coefficients or interpolation factors F for the calculation of these coefficients, it may be advantageous to store and use analytically derived interpolation factors F. This option is another embodiment of the invention.

The functions used for the calculation of the interpolation factors F of Eq. 12 can be very simple or more complex, depending on the desired accuracy of the novel coefficients used for the calculation of dose deposition and dose shielding. Actually, even the use of a single value of F=0.5 for all dose deposition calculations constitutes a large improvement over the currently recommended method of Eq. 2. Linear functions F between the origin and another point are defined by one parameter. It takes more than one parameter to define more complex interpolation functions F. The storage in computers of paramters of functions F used to calculate the novel coefficients, instead of the real coefficients, is another embodiment of the present invention. In the example shown below it will be demonstrated that use of a linear function F, starting at the origin and defined by only one parameter, can be used for calculations of the novel coefficients that can be expected to be sufficiently accurate for most practical applications.

One nice feature of the novel dose deposition coefficients and shielding coefficients is that they have real physical meaning and can be derived from one another. On could argue that the dose deposition coefficient is the primary one, because it is the dose deposition (energy absorption) in a shield what causes the shielding of radiation. The storage of only dose deposition coefficients or parameters needed for the calculation of dose deposition coefficients, and the calculation of shielding coefficients, whenever needed, by integration over a range of dose deposition coefficient is, therefore, one embodiment of the invention. The following paragraphs show how shielding coefficients can e calculated from available dose deposition coefficients.

Eq. 10 shows the dose deposited at a depth d in a depth increment of the thickness δd. When the incident energy fluence I_{d} passes through the thickness δd, it is being reduced to

I_{d}+δd=I_{d} exp(−μ_{d}δd). (Eq. 13)

I_{d} itself can be calculated from the reductions in all the preceding increments as

I_{d}=I₀ exp(−Σ(μ_{d}δd)) (Eq. 14)

where

I₀=incident fluence, at depth d=0

One novel feature of the invention is the introduction of a Shielding Coefficient μₛ which can be used for the calculation of the shielding by a simple exponential decay function similar to the Eq. 1 and Eq. 2,

I_{d}=I₀ exp(−μₛd) (Eq. 15)

Equating the exponents in the Eq. 14 and Eq. 15 yields the equation to be used for the computation of a novel Shielding Coefficient from the novel Dose Deposition Coefficients:

μₛ=(Σ(μ_{d}δd))/d (Eq. 16)

This Equation shows that the Shielding Coefficient for the depth d is the average of the Dose Deposition coefficients, from the depth 0 to the depth d. Just as the Dose Deposition Coefficient, the Shielding Coefficient is a function of the energy, the Z-number and the thickness of the absorber. Eq. 15, the Equation for the calculation of energy shielding, includes the dose buildup due to the secondary radiation of the original beam and, being a straight-forward exponential decay function, is is much simpler than the equivalent Equations 3 to 6. One embodiment of the invention is, therefore, the calculation of novel Shielding Coefficients from the novel Dose Deposition coefficients according to Eq. 16, for the calculation of dose shielding by a common exponential-decay function.

More data are currently available from shielding calculations and tests than from dose deposition calculations and tests. Another embodiment of the invention is, therefore, the storage in a computer of primary shielding coefficients or the storage of parameters needed for the calculation of shielding coefficients, with subsequent calculation of dose deposition coefficients from these shielding coefficients, if needed. The calculation of dose deposition coefficients from shielding coefficients is simpler than vice versa, because the calculation of only two shielding coefficients is necessary for the calculation of the dose deposition coefficients as the difference of the two shielding coefficients. An example is given below how dose deposition calculations can be derived from experimental shielding data.

Although current microcomputeres are fast enough to calculate one of the novel coefficients from the other, it is more efficient to store two sets of data in the computer that enable independent calculations of dose deposition coefficients and shielding coefficients. This option is another embodiment of the invention.

The methods described above can be best understood by demonstration of one example. Experimental data shown in FIG. 2, which have been around for a long time, are used as the starting point for an example of how experimental shielding data can be used for the derivation of the novel dose deposition and shielding coefficients, which then are used for the re-calculation of the measured data. FIG. 2 shows experimental data (circles) of dose shielding by lead. The upper curve in this Figure, labeled μ₀−σₛ, shows the decrease of energy fluence as calculated by the common exponential decay relation, using the common energy absorption coefficient denoted as μₑ throughout this specification. The lower curve in this Figure, labeled μ₀, shows the decrease of energy fluence as calculated by the common attenuation coefficients denoted as μₐ throughout this specification. Differentiation of the experimentally derived curve, i.e, calculation of its slope, is representative of the true dose deposited in that region which, according to the novel method of this invention, is calculated directly by multiplication of the mass (or width) of the increment in question with the novel dose deposition coefficient. Effects of any degradation of the incident beam that took place prior to arrival at the increment of interest need not be considered further. These effects are already included in the novel dose deposition coefficients, which are functions of not only the energy and the Z-number of the absorber, but also of the distance of the increment from the sourface of the absorber.

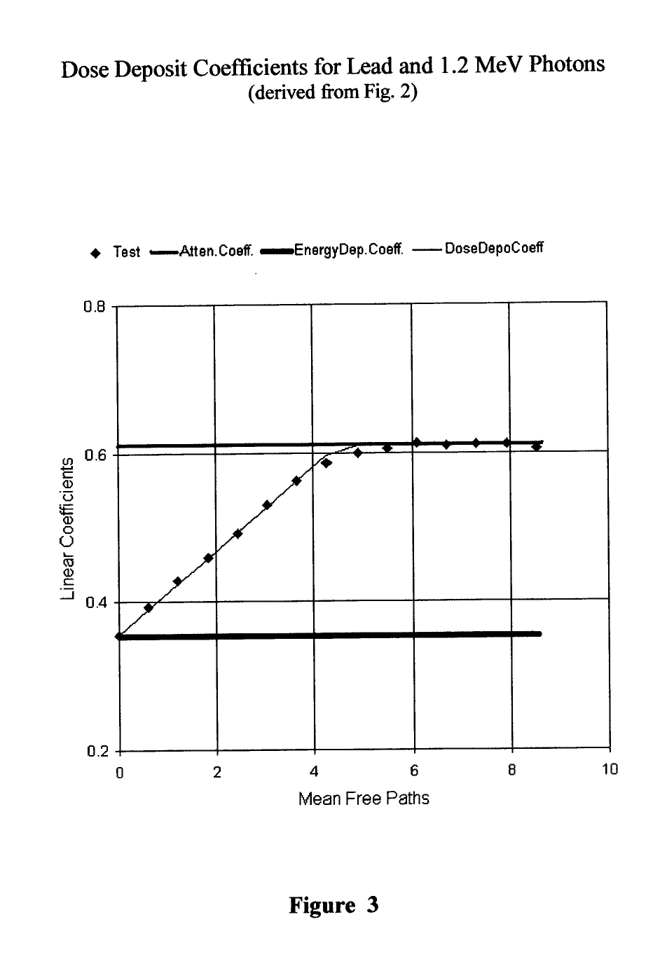

Visual examination of FIG. 2 leads to the recognition that the slope of the experimental curve is equal to the slope of the curve computed by the common energy absorption coefficient, which means that at zero thickness, the novel dose deposition coefficient is equal to the common energy absorption coefficient (μ_{d}=μₑ). At higher thicknesses (over about 8 cm), the slope of the experimental curve is equal to the slope of the exponential decay curve as computed with the common attenuation coefficient, ehich means that in this region the new dose deposition coefficient is equal to the common attenuation coefficient (μ_{d}=μₐ). Dose deposition coefficient for intermediate thicknesses were derived by graphical differentiation of FIG. 2 (with some inaccuracy) and plotted as diamonds in FIG. 3. For comparison purposes, this Figure also shows the common energy absorption coefficient μₑ (heavy horizontal line on the bottom) and the attenuation coefficient μₐ (lighter horizontal line at the top) for lead and 1.2 MeV photons.

Examination of FIG. 3. leads to the conclusion that a calculation of the novel dose deposition coefficients by Eq. 12 is probably the best and fastest way to go, at least at the present time. The interpolation function F_{D} for the calculation of the novel dose deposition coefficient is simply assumed to be a straight line between two points of FIG. 3, the first point being located at x=0 (where x is the thickness of the lead, in mean free paths) and μ_{d}=μₑ, and the second point being located at x=x₀ and μ_{d}=μₐ, where x0 is the “cutoff thickness”. This interpolation function can be expressed n one equation as

F_{D}=Min [1, x/x₀] (Eq. 17)

where

F_{D}=interpolation factor for the Dose Deposition Coefficient

x=shield thickness, im MFP

x₀=cutoff thickness

or in two equations as

F_{D}=x/x₀ for x<=x₀ (Eq. 18)

F_{D}=1 for x>x₀

Being linear equations, the Eq. 18 can be integrated easily according to Eq. 16, to yield the proper interpolation factors for the calculation of Dose Shielding:

F_{S}=x/(2 x₀) for x<=x₀ (Eq. 19)

F_{S}=1−x₀/(2 x) for x>x₀

The dose shielding of lead was then calculated according to Eq. 15, where μₛ was calculated in an equation similar to Eq. 12, i.e.,

μₛ=μₑ+F_{S}(μₐ−μₑ) (Eq. 20)

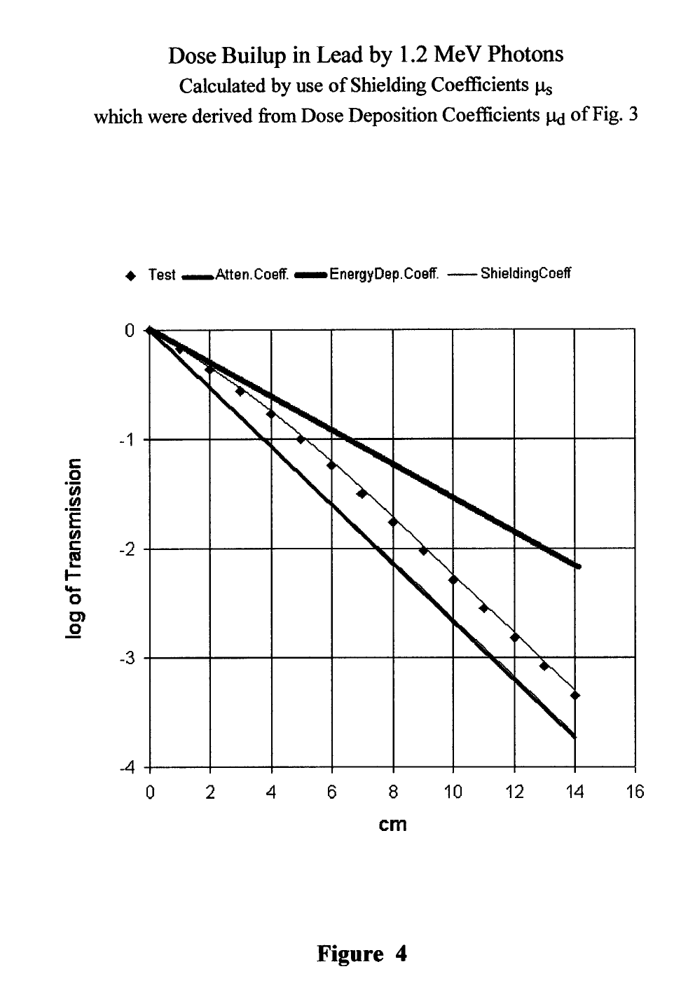

The calculated results, plotted as the line connecting the diamonds, agree well with the measured data of FIG. 2, shown in FIG. 4 as diamonds.

The only constant needed for the calculation of the FIGS. 18 and 19 is x₀, the cutoff depth where the dose deposition coefficient becomes equal to the attenuation coefficient. Preliminary studies have shown that the cutoff depth does not change much with the photon energy or with the Z-number of the shield, when it is defined in units of mean free path. A single numerical value of x₀ should result in acceptable accuracies for many situations. However, many published data exist on dose buildup factors, which can be used for the calculation of the dose shielding, which in turn can be used for the calculation of shielding coefficients and dose deposition coefficients as demonstrated in the example of the FIG. 2 and FIG. 3. These cutoff factors, calculated from measured data, can then be stored in the computer or the computer program as a two dimensional table and made available for the calculation of the novel dose deposition coefficients and shielding coefficients. The first dimension of the table of cutoff values is the photon energy, and the second dimension is the effective Z-number of the shield. Cutoff values for energies and materials that are not represented in tabular manner from measured data, could be obtained by interpolation or extrapolation of the data that were derived by tests. Currently, at the time of writing this specification, this is the preferred embodiment of the invention.

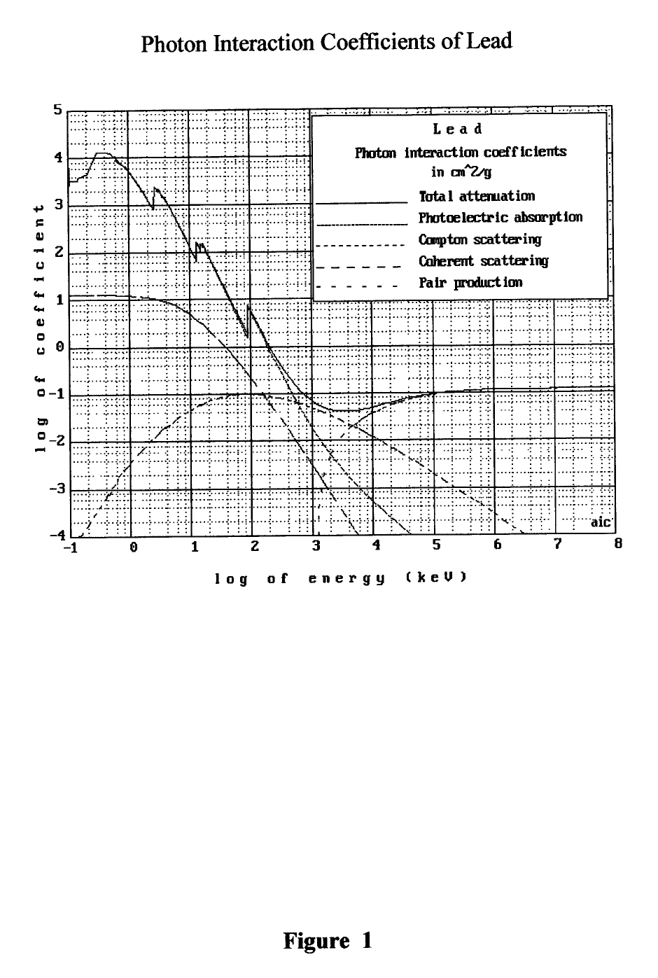

One significant difference between the novel coefficients of this invention and the common photon interaction coefficients in current use is that the common coefficients apply only to monoenergetic photons, whereas the novel dose deposition coefficients and shielding coefficients of the current invention also consider the effects of all secondary photons, which are of lower energy that the original photons. In other words, the novel coefficients are being used for accurate calculations of dose deposition and dose shielding of spectrally distibuted photons. As soon as a photons (of a minimum energy) enter a substance, they start producing secondary photons. The relative number of secondary photons increases as the primary photons advance into the substance. As the relative number of secondary photons increases, the average energy of the cloud of photons decreases and, because lower-energy photons have higher interaction coefficients (see FIG. 1), the dose depositon coefficient μ_{d} increases above the original value of μₑ, the energy absorption coefficient of photons of the original energy. There comes a time when the number of generated secondary photons is equal to the number of absorbed scondaries, the secondary photons reach an equilibrium with the primary photons, and the average energy of the cloud of photons no longer decreases. At this time the dose deposition coefficient μ_{d} becomes equal to the attenuation coeffcient μₐ which is a measure of removal of original photons from the cloud of photons. This process of increase and stabilization of the relative number of secondary photons, is nicely represented by the increase and stabilization of the novel dose deposition coefficient of this invention, as shown in FIG. 3. The process of energy degradation of the incident beam of photons is accurately represented by the increase of the novel dose deposition coefficient. Actually, it makes technical sense to calculate an “effective energy” Eₑ of the degraded photons at any given depth of the absorber, by calculating that particular photon energy which would have the same energy absorption coefficient μₑ as the dose deposition coefficient μ_{d} at that particular depth.

With the established capability of the current invention to deal with spectrally distributed photons, it is easy to expand this concept to spectrally ditributed original photons, such as found in X-ray spectra and bremsstrahlung spectra generated by higher-energy electrons. In a first step of calculating dose deposition and dose shielding of X-rays and bremsstrahlung spectra, one can calculate the surface dose deposited by the spectra by using appropriate dose absorption coefficients □ₑ for each one of the energy bins of the spectrum According to the definition of energy absorption coefficients, this step will give the accurate surface dose deposited by the spectrum In a second step, an effective energy Eₑ can be calculated for the incident spectrum, just as discussed in the paragraph above, by calculating that particular energy which would generate the same surface dose as the incident spectrum, by use of the corresponding energy absorption coefficient □ₑ, under the assumption that the intensity of the spectrally distributed photons and the monoenergetic photons is the same. By definition, the surface dose deposited by the monoenergetic photons of the energy Eₑ will be identical to the surface dose of the spectrum. From here on, the dose deposition coefficients and shielding coefficients for the effective energy Eₑ will be derived in the same manner as discussed above for monoenergetic photons. Just as for monoenergetic photons, the models applied for the calculation of dose deposition calculations and shielding coefficients can be verified by tests. This method of calculating the dose deposition and dose shielding by photons with spetrally distributed energies is also an embodiment of the current invention and can be expected to significantly increase the speed and accuracy of current engineering-type calculations. Since many of the radiation sources used in industrial and medical applications are not monoenergetic but have spectral distributions, and since no methods exist at the present time which deal with the problems of spectrally distributed photons, this particular embodiment of the invention can be expected to find wide application in the field.

I claim:

1. A method for the calculation of dose deposition in matter by incident photons, by use of dose deposition coefficients which are not only a function of the energy of said incident photons and the atomic number Z of said matter but also a function of the amount of other material through which said incident photons may have passed before reaching said matter, resulting in true dose values which do not need to be corrected for the effects of any changes that said incident photons may have experienced while passing through said other material.

2. A method for the calculation of the reduction by shielding material of the dose generated by incident photons, by use of shielding coefficients which are not only a function of the energy of said incident photons and the atomic number of of said shielding material but also of the thickness of said shielding material, resulting in true dose shielding values which do not need to be corrected for the effects of any changes which said incident tphotons may have experienced while passing through said shielding material.

3. The methods of claim 1 and claim 2, wherein the said dose deposition coefficients and the said shielding coefficients are related to one another, wherein said dose deposition coefficients of a material can be derived by differentiation of the shielding of said material as calculated by said shielding coefficients, and wherein said shielding coefficients of said material can be derived by integration of the dose deposition as calculated by said dose deposition coefficients.

4. A digital computing means comprising a processor capable of processing a computer program for the calculation of said dose deposition coefficients of claim 1 and the calculation of said shielding coefficients of claim 2, and further comprising storage means capable of storing arrays of data needed by said computer program for the calculation of said dose deposition coefficients and said shielding coeffiecients.

5. A method for deriving the whole practical range of said dose deposition coeffcients of claim 1 by performing experimental measurements of dose deposition at different depths in a material exposed to said incident photons of claim 1, deriving the said dose deposition coeffcients that would result in the measured dose at said different depths, labeling said derived dose deposition coefficients with the energy of said incident photons, the atomic number Z of said material and the depths in said material at which the measurements were made, then arranging the said derived dose deposition coefficients with other experimentally determined said dose deposition coefficients in a data array, storing said data array in either the said storage means of said digital computing means of claim 4 or imbedding said data array in the said computer program of claim 4, and then extracting any needed said dose deposition coefficients from the stored or imbedded said data array by using one of the stored said dose deposition coefficients or by interpolation or extrapolation between the stored or imbedded data to derive a said dose deposition coefficient for any photon energy, atomic number Z or depth.

6. A method for deriving the whole practical range of said shielding coeffcients of claim 2 by performing experimental measurements of dose shielding by placing shielding material of different thichnesses into the path of said incident photons of claim 1, measuring the dose behind the shield, computing the dose reduction by the said shielding material, deriving the said shielding coeffcients that would result in the measured dose reduction for the said different thicknesses, labeling said derived shielding coefficients with the energy of said incident photons, the atomic number Z of said shielding material and the thicknesses of said shielding material behind which the measurements were made, then arranging the said derived shielding coefficients with other experimentally determined said shielding coefficients in a data array, storing said data array in either the said storage means of said digital computing means of claim 4 or imbedding said data array in the said computer program of claim 4, and then extracting any needed said shielding coefficients from the stored or imbedded said data array by using one of the stored said shielding coefficients or by interpolation or extrapolation between the stored or imbedded data to derive a said shielding coefficient for any photon energy, atomic number Z or shield thickness.

7. A method to calculate said dose deposition coefficients of claim 1 for any energy of said incident photons, for any atomic number Z and for any depth at which said matter of claim 1 may be located, by calculating from available data the attenuation coefficient and the energy absorption coeffcient for said energy of said incident photons and for the atomic number Z of said material, and then calculating said dose deposition coefficients for any desired depth by interpolation between the energy absorption coefficient and the attenuation coefficient by use of an interpolation function, with the parameters of said interpolation function having been determined previously and having been stored in said storage means of said computing means of claim 4 or imbedded in said computer program of claim 4.

8. A method to calculate said shielding coefficients of claim 2 for any energy of said incident photons, for any atomic number Z and for any thickness of said shielding material of claim 2, by calculating from available data the attenuation coefficient and the energy absorption coeffcient for said energy of said incident photons and for the atomic number Z of said shielding material, and then calculating said shielding for any desired thickness by interpolation between the energy absorption coefficient and the attenuation coefficient by use of an interpolation function, with the parameters of said interpolation fiction having been determined previously and having been stored in said storage means of said computing means of claim 4 or imbedded in said computer program of claim 4.

9. An interpolation function for the calculation of dose deposition coefficients according to the method of claim 7, wherein said interpolation function for interpolation between the energy absorption coeffcient μₑ and the attenuation coefficient μₐ includes an interpolation factor F_{D} between 0 an 1 and which has the form μ_{d}=μₑ+F_{D} (μₐ−μₑ), said interpolation function representing two straight lines when drawn in a coordinate system in which the abscissa is the depth x in the exposed matter and the ordinate is the said dose deposition coefficient μ_{d}, and wherein the first line extends from a point (x=0, μ_{d}=μₑ) to a point (x=x₀, μ_{d}=μₐ), and the second line extens from the point (x=x₀, μ_{d}=μₐ) to (x=infiniy, μ_{d}=μₐ), and which can be expressed by the two mathematical formulas for the said interpolation factor, by F_{D}=x/x₀ for x<=x₀ and by F_{D}=1 for x>x₀, and wherein x₀ is the only parameter of the function to be stored in said storage means of said computing means of claim 4 or to be imbedded in said computer program of claim 4.

10. An interpolation function for the calculation of shielding coefficients by integrating according to claim 3 the dose deposition coeffiients derived by the interpolation function of claim 8, wherein said interpolation function has the form μₛ=μₑ+F_{S} (μₐ−μₑ) which is similar to the interpolation function for dose deposition coefficients, and wherein the interpolation factor can be expressed in the two mathematical formulas, by F_{S}=x/(2 x₀) for x<=x0 and by F_{S}=1−x₀/(2x) for x >x₀, and wherein x₀ is the same parameter of interpolation function for dose deposition coefficients.

11. A method for the calculation of dose deposition and dose shielding of photons which are not monoenergetic but which are spectrally distributed, such as X-rays or bremstrahlung specta, whereby an effective energy Eₑ is calculated for the incident spectrum and the same methods as claimed in the claims 1 to 10 for monoenergetic photons are used for the calculation of dose deposition and dose shielding of said spectrally distributed photons, said effective energy Eₑ being calculated by first calculating the surface dose deposited by the spectrally distributed photons using common energy absorption coefficients μₑ, and then calculating that single energy which would result in the same surface dose, assuming that the intensities of the spectrally distributed photons and the monoenergetic photons with energy Eₑ have the same intensity.
